(19) United States
(12) Patent Application Publication
(10) Pub. No.: US 2023/0094446 A1
(43) Pub. Date: Mar. 30, 2023

(54) PARKING ASSISTANCE DEVICE, PARKING ASSISTANCE METHOD, AND VEHICLE

(71) Applicant: PANASONIC INTELLECTUAL PROPERTY MANAGEMENT CO., LTD., Osaka (JP)

(72) Inventor: Hirotaka KAMIYAMA, Kanagawa (JP)

(73) Assignee: PANASONIC INTELLECTUAL PROPERTY MANAGEMENT CO., LTD., Osaka (JP)

(21) Appl. No.: 17/946,652

(22) Filed: Sep. 16, 2022

(30) Foreign Application Priority Data
Sep. 30, 2021 (JP) 2021-161236

(51) Int. Cl. G06V 20/58; G08G 1/16; G06V 20/56; G06V 20/59; B60W 30/06

(52) U.S. Cl. CPC G06V 20/586; G08G 1/168; G06V 20/588; G06V 20/593; B60W 30/06; B60W 2420/42; B60W 2540/049

(57) ABSTRACT

A parking assistance device is configured to assist parking of a vehicle. The parking assistance device includes: a communication interface; a processor; and a memory. The memory stores instructions that, when executed by the processor, cause the parking assistance device to perform operations. The operations include: obtaining an image of a parking frame through the communication interface, the image being captured by the image capturing device provided in the vehicle; and determining, based on a number of one or more occupants in the vehicle, a correction value of a position of each of at least one end point of the parking frame detected from the image.

### TECHNICAL FIELD

The present disclosure relates to a parking assistance device, a parking assistance method, and a vehicle.

### BACKGROUND ART

There is a technique in which a parking frame of a vehicle in a parking lot is detected from an image captured by an image capturing device (for example, a camera) mounted on the vehicle, and parking of the vehicle in the parking frame is assisted using a detection result thereof. In order to correctly detect the parking frame from the image captured by the image capturing device, calibration of the image capturing device is performed (JP2016-149711A and JP2017-188743A).

### SUMMARY OF INVENTION

The calibration of the image capturing device is performed in a state where no occupant is in the vehicle. Therefore, when the occupant is in the vehicle, the image capturing device may approach the ground, and the parking frame may not be correctly detected from the captured image of the image capturing device.

An object of the present disclosure is to provide a technique capable of more correctly detecting a parking frame from a captured image.

The present disclosure provides a parking assistance device configured to assist parking of a vehicle, the parking assistance device including: a communication interface; a processor; and a memory storing instructions that, when executed by the processor, cause the parking assistance device to perform operations, the operations including: obtaining an image of a parking frame through the communication interface, the image being captured by the image capturing device provided in the vehicle; and determining, based on a number of one or more occupants in the vehicle, a correction value of a position of each of at least one end point of the parking frame detected from the image.

The present disclosure provides a parking assistance method for assisting parking of a vehicle, the parking assistance method including: obtaining an image of a parking frame captured by an image capturing device provided in the vehicle; and determining, based on a number of one or more occupants in the vehicle, a correction value of a position of an end point of the parking frame detected from the image.

The present disclosure provides a vehicle including: an image capturing device; a detection device; at least one processor; and at least one memory storing instructions that, when executed by the at least one processor, cause the vehicle to perform operations, the operations including: obtaining an image of a parking frame captured by the image capturing device; determining, based on detection information detected by the detection device indicating a number of one or more occupants in the vehicle, a correction value of a position of an end point of the parking frame detected from the image; specifying a path for parking the vehicle in the parking frame corrected by using the correction value; and controlling movement of the vehicle based on the path.

It should be noted that these comprehensive or specific aspects may be implemented by a system, a device, a method, an integrated circuit, a computer program, or a recording medium, or may be implemented by any combination of the system, the device, the method, the integrated circuit, the computer program, and the recording medium.

According to the present disclosure, a parking frame can be more correctly detected from a captured image.

### BRIEF DESCRIPTION OF DRAWINGS

FIG. 1 is a schematic diagram showing a configuration example of a vehicle according to the present embodiment.

FIG. 2 is a block diagram showing a configuration example of the vehicle and a parking assistance device according to the present embodiment.

FIGS. 3A to 3C are diagrams showing an outline of parking assistance of the vehicle.

FIG. 4 is a flowchart of an outline of processing of the parking assistance device.

FIG. 5 is a diagram showing a deviation between an end point of an actual target parking frame and an end point detected from a captured image.

FIG. 6 is a schematic diagram showing positions of seats of the vehicle.

FIG. 7 is a schematic diagram showing a relative positional relationship between an image capturing device of the vehicle and the target parking frame.

FIG. 8 is a diagram showing an example of a correction value table for a first end point when an opening width is 3500 mm.

FIG. 9 is a diagram showing an example of a correction value table for a second end point when the opening width is 3500 mm.

FIG. 10 is a diagram showing an example of a correction value table of a first end point when the opening width is 2300 mm.

FIG. 11 is a diagram showing an example of a correction value table of a second end point when the opening width is 2300 mm.

### DESCRIPTION OF EMBODIMENTS

Hereinafter, an embodiment according to the present disclosure will be described in detail with reference to the drawings as appropriate. However, unnecessarily detailed description may be omitted. For example, detailed descriptions of well-known matters and redundant descriptions of substantially the same configurations may be omitted. This is to avoid unnecessary redundancy in the following description and to facilitate understanding of those skilled in the art. It should be noted that the accompanying drawings and the following description are provided for those skilled in the art to fully understand the present disclosure, and are not intended to limit the subject matter described in the claims.

### Present Embodiment

<Configuration of Vehicle>

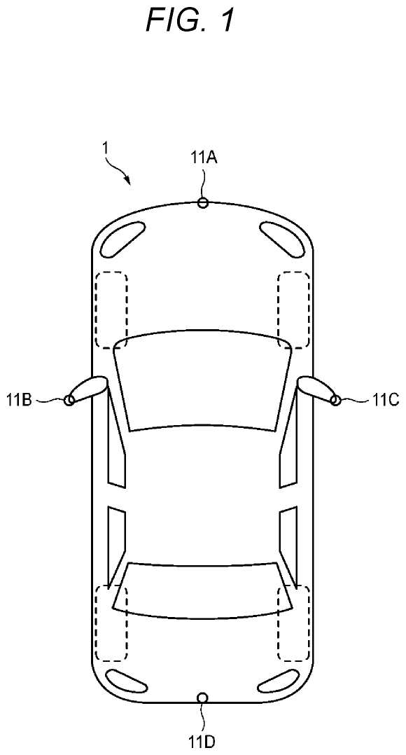

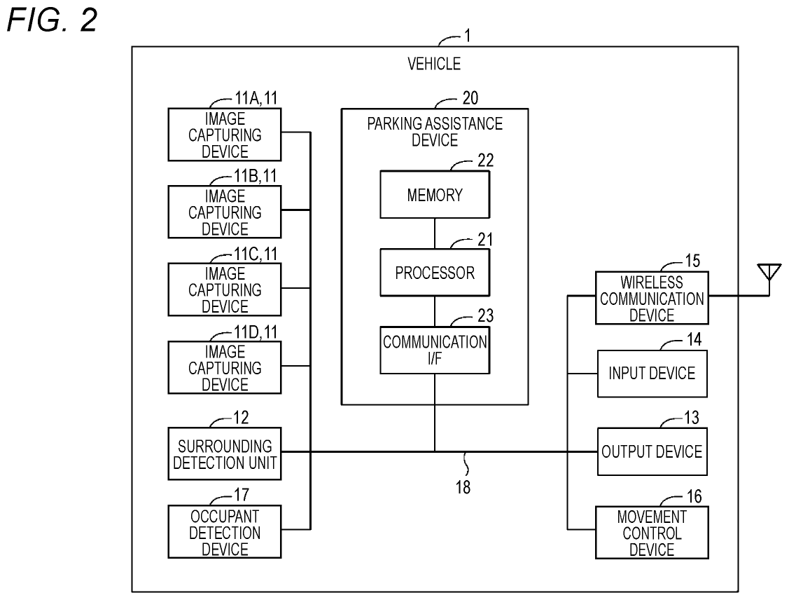

An example of a configuration of a vehicle 1 according to the present embodiment will be described with reference to FIGS. 1 and 2. FIG. 1 is a schematic diagram showing the configuration example of the vehicle 1 according to the present embodiment. FIG. 2 is a block diagram showing a configuration example of the vehicle 1 and a parking assistance device 20 according to the present embodiment.

The vehicle 1 includes an image capturing device 11 (11A, 11B, 11C, and 11D), a surrounding detection device 12, an output device 13, an input device 14, a wireless communication device 15, a movement control device 16, an occupant detection device 17, and the parking assistance device 20. These devices 11, 12, 13, 14, 15, 16, 17, and 20 may transmit and receive information to and from each other through an in-vehicle network 18. Examples of the in-vehicle network 18 include controller area network (CAN), LIN, and FlexRay.

The image capturing device 11A is provided in, for example, a front grille of the vehicle 1, and captures an image of a front of the vehicle 1. An example of the image capturing device 11A may be a front camera.

The image capturing device 11B is provided on, for example, a left side mirror of the vehicle 1, and captures an image of a left side of the vehicle 1. The image capturing device 11B may be installed such that an image of at least left ground of the vehicle 1 is captured. An example of the image capturing device 11B may be a left side camera.

The image capturing device 11C is provided on, for example, a right side mirror of the vehicle 1, and captures an image of a right side of the vehicle 1. The image capturing device 11C may be installed such that an image of at least right ground of the vehicle 1 is captured. An example of the image capturing device 11C may be a right side camera.

The image capturing device 11D is provided, for example, in the vicinity of a trunk of the vehicle 1, and captures an image of a rear side of the vehicle 1. An example of the image capturing device 11D may be a rear camera.

The surrounding detection device 12 detects a situation around an outside of the vehicle 1. Examples of the surrounding detection device 12 include at least one of a camera, a millimeter wave radar, and a light detection and ranging (LiDAR).

The output device 13 is provided in the vehicle 1 and outputs various kinds of information to an occupant (including a driver) of the vehicle 1. Examples of the output device 13 include a display and a speaker.

The input device 14 is provided in the vehicle 1 and receives an instruction from the occupant of the vehicle 1. Examples of the input device 14 include a button, a switch, a dial, a touch panel, and a microphone.

The wireless communication device 15 may transmit and receive various types of information through a cellular network (not shown). Examples of the cellular network include long term evolution (LTE), 4G, and 5G.

The movement control device 16 controls movement of the vehicle 1. The movement control device 16 may control steering of the vehicle 1 in response to a steering wheel operation by the driver or in response to an instruction from the parking assistance device 20 to be described later. The movement control device 16 may control acceleration, deceleration, or shift switching of the vehicle 1 in response to an accelerator operation, a brake operation, or a shift lever operation by the driver.

The occupant detection device 17 is a device that detects the number of occupants in the vehicle 1. Further, the occupant detection device 17 may detect which seat of the vehicle 1 the occupant is seated in. For example, the occupant detection device 17 may detect a seat on which the occupant is seated in accordance with a detection result of a weight sensor provided in each of the seats. Alternatively, the occupant detection device 17 may detect the seat on which the occupant is seated in accordance with a wearing state of a seat belt mounted on each of the seats.

The parking assistance device 20 assists the parking of the vehicle 1 in a parking frame. The parking assistance device 20 may include a processor 21, a memory 22, and a communication interface (I/F) 23. The processor 21 executes processing of the parking assistance device 20 in cooperation with the memory 22 or the communication I/F 23. The processor 21 may read a program from the memory 22 and execute the program. The processor 21 may transmit and receive information to and from other devices through the communication I/F 23. Examples of the processor 21 may include a central processing unit (CPU), a control circuit, a controller, and a large scale integration (LSI). The memory 22 stores programs, data, or the like. The memory 22 may include a read-only memory (ROM) and a random access memory (RAM). The memory 22 may include a flash memory as an example of a nonvolatile storage medium. The communication I/F 23 may be connected to the in-vehicle network 18. The processing mainly performed by the parking assistance device 20, which will be described later, may be the processing mainly performed by the processor 21 of the parking assistance device 20. The parking assistance device 20 may be configured as an electronic control unit (ECU). It should be noted that details of the processing of the parking assistance device 20 will be described later.

<Outline of Parking Assistance>

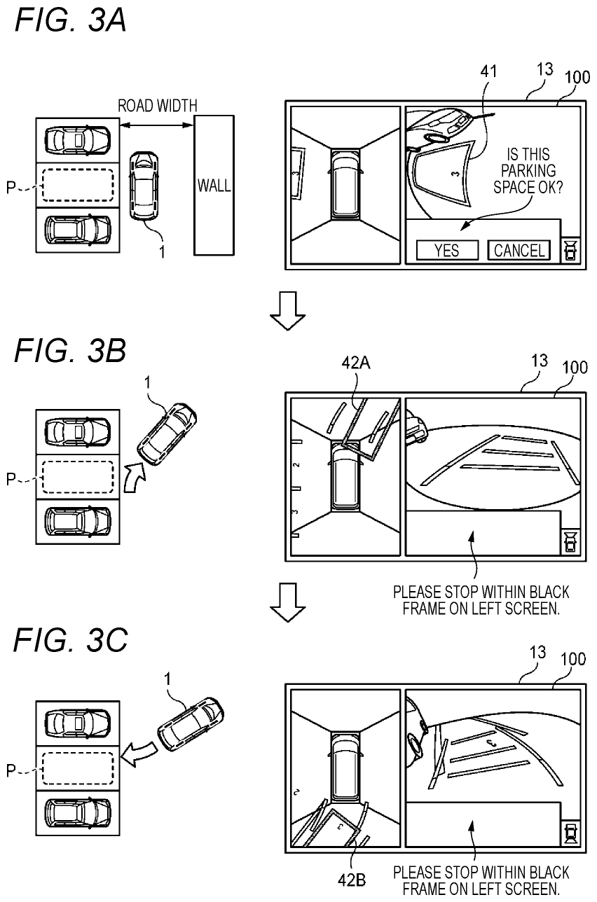

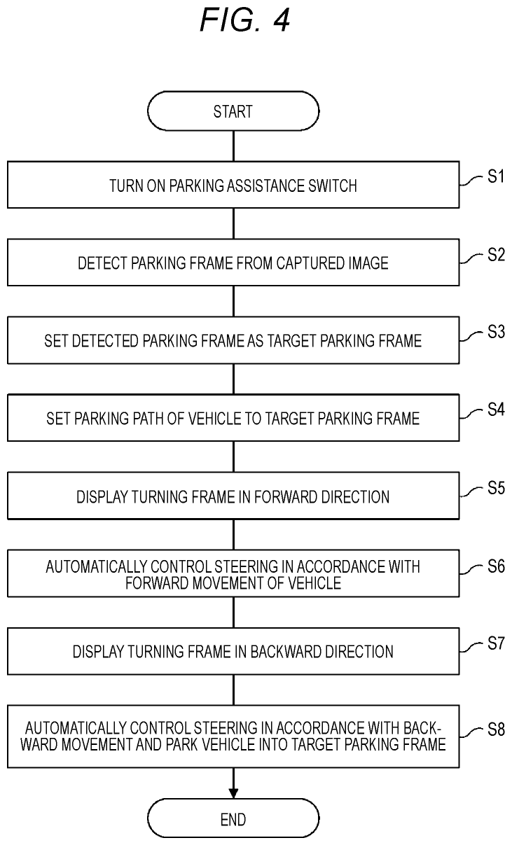

An overview of parking assistance of the vehicle 1 will be described with reference to FIGS. 3A to 3C and FIG. 4. FIGS. 3A to 3C are diagrams showing the outline of the parking assistance of the vehicle 1. FIG. 4 is a flowchart of an outline of the processing of the parking assistance device 20.

First, as shown in FIG. 3A, the driver stops the vehicle 1 beside a parking frame P in which the vehicle 1 is desired to be parked.

The driver turns on a parking assistance switch serving as one of the input devices 14 (S1). Accordingly, the parking assistance device 20 starts the following processing.

The parking assistance device 20 detects the parking frame P from an image (hereinafter, referred to as a captured image) 100 captured by the image capturing device 11B close to the parking frame P in which the vehicle 1 is desired to be parked (S2).

As shown in FIG. 3A, the parking assistance device 20 displays the parking frame P detected in step S2 on the output device 13, and inquires of the driver whether to park the vehicle 1 in the parking frame P.

When the driver instructs to park the vehicle 1 in the parking frame P through the input device 14 (for example, when the driver selects a “YES” button in FIG. 3A), the parking assistance device 20 sets the parking frame P as a target parking frame 41 (S3).

The parking assistance device 20 specifies and sets a path (hereinafter, referred to as a parking path) for parking the vehicle 1 in the target parking frame 41 (S4).

As shown in FIG. 3B, the parking assistance device 20 determines a turning frame 42A in a forward direction of the vehicle 1 based on the parking path, and displays the turning frame 42A on the output device 13 (S5).

The parking assistance device 20 automatically controls the steering through the movement control device 16 such that the vehicle 1 moves into the turning frame 42A in the forward direction in accordance with forward movement of the vehicle 1 (S6). At this time, the driver may drive the vehicle 1 forward by operating an accelerator or a brake without operating the steering wheel. Alternatively, the parking assistance device 20 may automatically control the accelerator or the brake through the movement control device 16.

As shown in FIG. 3C (S7), when the vehicle 1 moves into the turning frame 42A in the forward direction, the parking assistance device 20 determines a turning frame 42B in a backward direction of the vehicle 1 based on the parking path and displays the turning frame 42B on the output device 13. The turning frame 42B may be displayed in the target parking frame 41.

The parking assistance device 20 automatically controls the steering through the movement control device 16 such that the vehicle 1 moves into the turning frame 42B in the backward direction in accordance with backward movement of the vehicle 1 (S8). At this time, the driver may drive the vehicle 1 backward by operating the accelerator or the brake without operating the steering wheel. Alternatively, the parking assistance device 20 may automatically control the accelerator or the brake through the movement control device 16.

When the vehicle 1 moves into the turning frame 42B in the backward direction, that is, into the target parking frame 41, the parking assistance device 20 ends the processing.

Accordingly, the driver can easily park the vehicle 1 in the target parking frame 41 only by operating the accelerator or the brake.

<Deviation of End Point of Parking Frame>

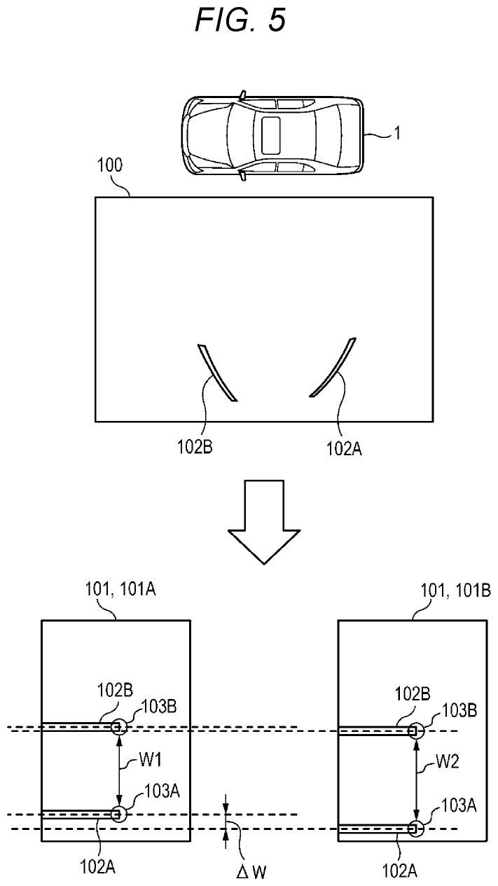

A deviation between an end point of the actual target parking frame 41 and an end point detected from the captured image 100 will be described with reference to FIG. 5. FIG. 5 is a diagram showing the deviation between the end point of the actual target parking frame 41 and the end point detected from the captured image 100. The captured image 100 shown in FIG. 5 is captured by the image capturing device 11B (left side camera).

The parking assistance device 20 transforms the captured image 100 including two white lines 102A and 102B of the target parking frame 41 into images for detecting the two white lines 102A and 102B of the target parking frame 41. Hereinafter, the transformed image is referred to as a parking frame detection image 101. The parking frame detection image 101 may be obtained by transforming the captured image 100 into a bird's-eye view image. In the present embodiment, the parking frame is described as a white line, and a color of the parking frame is not limited to white. Therefore, the white line of the parking frame may be an example of a line of the parking frame.

The parking assistance device 20 detects the two white lines 102A and 102B from the parking frame detection image 101 and defines the target parking frame 41. Then, based on the two white lines 102A and 102B of the target parking frame 41 detected from the parking frame detection image 101, the parking assistance device 20 detects an end point of the white line 102A close to the image capturing device 11 as a first end point 103A, and detects an end point of the white line 102B close to the image capturing device 11 as a second end point 103B.

A parking frame detection image 101A in FIG. 5 shows an example of the parking frame detection image 101 when no occupant is in the vehicle 1, and a parking frame detection image 101B in FIG. 5 shows an example of the parking frame detection image 101 when the occupant is in the vehicle 1.

When the occupant is in the vehicle 1, the vehicle 1 sinks due to a weight of the occupant, and the image capturing device 11 approaches the ground. Therefore, as shown in FIG. 5, in the parking frame detection image 101B when the occupant is in the vehicle 1, a distance between the first end point 103A of the white line 102A of the target parking frame 41 and the second end point 103B of the white line 102B may be detected to be larger than that in the parking frame detection image 101A when no occupant is in the vehicle 1. For example, the distance between the first end point 103A and the second end point 103B (hereinafter referred to as the distance between the end points) may be estimated to be W1 (for example, 3500 mm) when no occupant is in the vehicle 1, and may be estimated to be W2 (for example, 3900 mm) which is larger than W1 when the occupant is in the vehicle 1. That is, the deviation of ΔW (=W2-W1) may occur in the distance between the end points when the occupant is in the vehicle 1 and when no occupant is in the vehicle 1. It should be noted that in the present embodiment, an actual distance between the white line 102A and the white line 102B or an actual distance between the first end point 103A and the second end point 103B may be referred to as an opening width which represents a width of an entrance of the target parking frame 41.

Therefore, in the following, the parking assistance device 20 that appropriately estimates the distance between the end points by correcting the positions of the first end point 103A and the second end point 103B when the occupant is in the vehicle 1 will be described.

<Detection of the Number of Occupants and Seating Position>

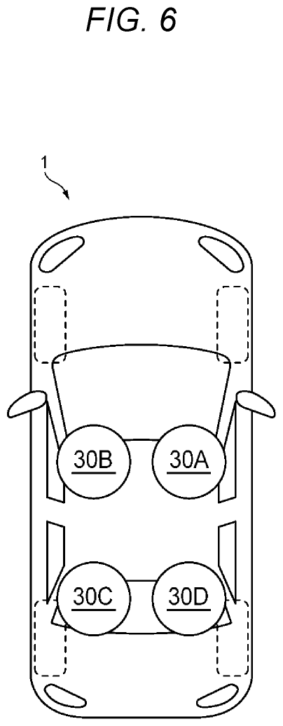

Detection of the number of occupants in the vehicle 1 and a seating position will be described with reference to FIG. 6. FIG. 6 is a schematic diagram showing positions of seats of the vehicle 1.

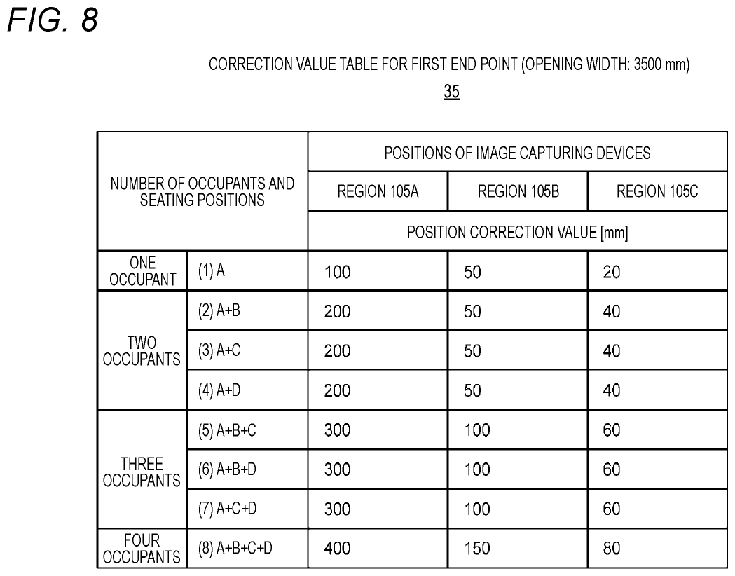

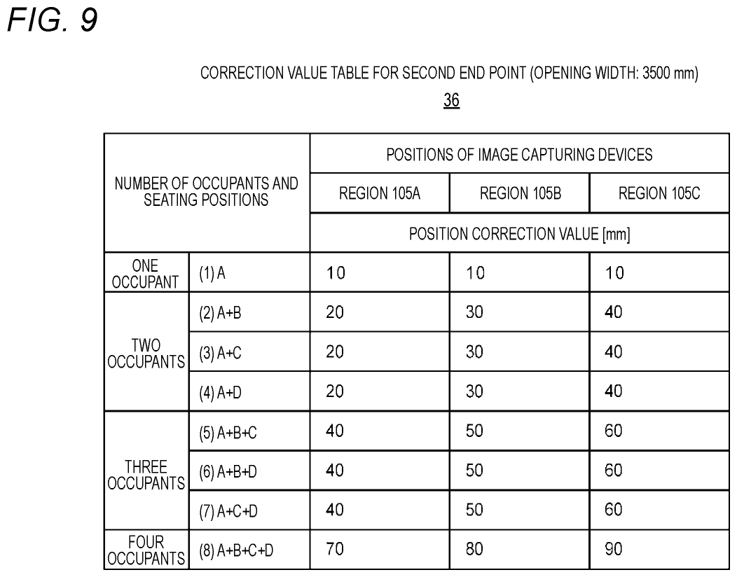

For example, the occupant detection device 17 detects in which seat the occupant is seated according to the detection result of the weight sensor provided in each of seats 30A, 30B, 30C, and 30D or the wearing state of the seat belts. Accordingly, the occupant detection device 17 can detect the number of occupants in the vehicle 1 and the seating position. The detection result is used to determine correction values of the positions of the first end point 103A and the second end point 103B, which will be described later with reference to FIGS. 8 and 9. It should be noted that FIG. 6 shows an example in which the vehicle 1 includes four seats, and the number of seats included in the vehicle 1 may be any number. The positions of the seats are not limited to the example shown in FIG. 6.

<Detection of Relative Position of Image Capturing Device with Respect to Target Parking Frame>

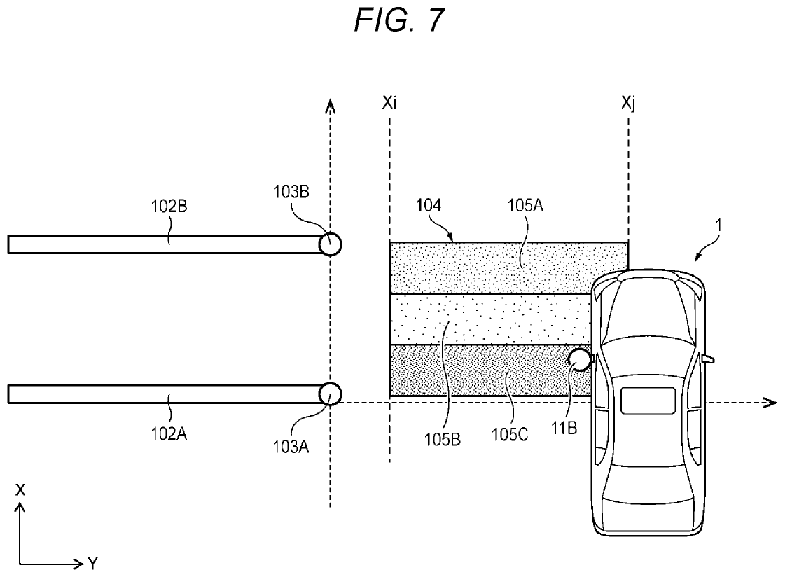

Detection of a relative position of the image capturing device 11B with respect to the target parking frame 41 will be described with reference to FIG. 7. FIG. 7 is a schematic diagram showing a relative positional relationship between the image capturing device 11B of the vehicle 1 and the target parking frame 41. It should be noted that FIG. 7 shows an example in which the target parking frame 41 is present on the left side of the vehicle 1, and the target parking frame 41 may be present on the right side of the vehicle 1. In this case, the parking assistance device 20 may detect a relative position of the image capturing device 11C (right side camera). Similarly, the parking assistance device 20 may detect a relative position of the image capturing device 11A (front camera) when the target parking frame 41 is present in front of the vehicle 1, and may detect a relative position of the image capturing device 11D (rear camera) when the target parking frame 41 is present behind the vehicle 1.

When the image capturing device 11B (left side camera) is located within a parking frame detection range 104, the parking assistance device 20 may start the parking assistance. At this time, the parking assistance device 20 specifies which of regions 105A, 105B, and 105C included in the parking frame detection range 104 the image capturing device 11B is located in. The parking frame detection range 104 may be rectangular, and two sides defining the parking frame detection range 104 may be obtained by extending the two white lines 102A and 102B of the target parking frame 41 toward the vehicle 1. As shown in FIG. 7, the regions 105A, 105B, and 105C of the parking frame detection range 104 may be regions obtained by dividing the parking frame detection range 104 into three regions in a traveling direction of the vehicle 1.

For example, the parking assistance device 20 specifies which of the regions 105A, 105B, and 105C included in the parking frame detection range 104 the image capturing device 11B is located in based on the positions of the two white lines 102A and 102B of the target parking frame 41 in the parking frame detection image 101. A specification result thereof is used to determine the correction values of the positions of the first end point 103A and the second end point 103B, which will be described later with reference to FIGS. 8 and 9. It should be noted that FIG. 7 shows an example in which the parking frame detection range 104 is divided into three regions, and the number of divisions may be any number.

Next, an example of a method for determining the correction values of the first end point 103A and the second end point 103B will be described. It should be noted that in this description, for convenience, as shown in FIG. 7, a direction in which the vehicle 1 travels is defined as an X axis, and an axis along the ground (for example, parallel to the ground) and perpendicular to the X axis is defined as a Y axis. In addition, it is assumed that the two white lines 102A and 102B are parallel to the Y axis. It should be noted that these directions are used for convenience of description, and do not limit directions of the correction of the first end point 103A and the second end point 103B with respect to the vehicle 1 when the parking assistance device 20 is actually used.

<Method for Determining Correction Value of First End Point when Opening Width is 3500 mm>

The method for determining the correction value of the first end point 103A will be described with reference to FIG. 8. FIG. 8 shows an example of a correction value table 35 for the first end point when the opening width is 3500 mm.

As described above, the parking assistance device 20 detects the position of the first end point 103A from the white line 102A of the target parking frame 41 in the parking frame detection image 101, and detects the position of the second end point 103B from the white line 102B. Here, when the target parking frame 41 is estimated based on the positions of the first end point 103A and the second end point 103B, the following problem may occur. That is, in the parking frame detection image 101 when the occupant is in the vehicle 1, the position of at least one of the first end point 103A and the second end point 103B may be detected as being shifted from the actual position of the end point. As a result, the parking assistance device 20 may erroneously determine an estimated size of the target parking frame 41 and may not be able to correctly park the vehicle 1 in the target parking frame 41.

Further, since the positions and distortions of the first end point 103A and the second end point 103B in the captured image 100 may change due to a difference in the relative position of the image capturing device 11B with respect to the target parking frame 41, the positions of the first end point 103A and the second end point 103B when converted into the parking frame detection image 101 may also change. Therefore, in the parking frame detection image 101 in which the relative position of the image capturing device 11B with respect to the target parking frame 41 is different, the distance between the first end point 103A and the second end point 103B of the target parking frame 41 may be calculated to be larger (or smaller) than the actual distance. That is, the parking assistance device 20 may erroneously determine the estimated size of the target parking frame 41.

Therefore, the parking assistance device 20 accurately estimates the target parking frame 41 by correcting the position of at least one of the first end point 103A and the second end point 103B in accordance with at least one of the number of occupants in the vehicle 1, the seating position of the occupant, and the relative position of the image capturing device 11B with respect to the target parking frame 41. The correction value table 35 for the first end point is a table for determining a magnitude of the correction of the position of the first end point 103A, and a correction value table 36 for the second end point is a table for determining a magnitude of the correction of the position of the second end point 103B.

First, the correction value table 35 for the first end point will be described. As shown in FIG. 8, the correction value table 35 for the first end point may be a table that associates the number of occupants in the vehicle 1 and the seating position, the regions 105A, 105B, and 105C, and the correction value of the position of the first end point 103A. The correction value table 35 for the first end point may be stored in advance in the memory 22 of the parking assistance device 20. The correction values in the correction value table 35 for the first end point shown in FIG. 8 correspond to the image capturing device 11B (left side camera). Therefore, the correction values in the correction value table 35 for the first end point corresponding to the image capturing device 11C (right side camera) may be different from the correction values shown in FIG. 8. The correction values in the correction value table 35 for the first end point may be different for each vehicle type. The correction values in the correction value table 35 for the first end point may be determined by experiment, simulation, or the like. It should be noted that the correction value table 35 for the first end point may be an example of correction value information of the first end point 103A.

When the opening width of is 3500 mm, the parking assistance device 20 refers to the correction value table 35 for the first end point shown in FIG. 8, and performs, for example, the following processing.

When it is detected that the occupant is seated on the seat 30A and the image capturing device 11B is located in the region 105A, the parking assistance device 20 determines the correction value of the first end point 103A to be 100 mm with reference to the correction value table 35 for the first end point shown in FIG. 8. That is, the parking assistance device 20 corrects the position of the first end point 103A to a position shifted by 100 mm in an X axis direction.

When it is detected that the occupants are seated on the seats 30A and 30B and the image capturing device 11B is located in the region 105A, the parking assistance device 20 determines the correction value of the first end point 103A to be 200 mm with reference to the correction value table 35 for the first end point shown in FIG. 8. That is, the parking assistance device 20 corrects the position of the first end point 103A to a position shifted by 200 mm in the X axis direction.

When it is detected that the occupants are seated on the seats 30A, 30B, and 30C and the image capturing device 11B is located in the region 105A, the parking assistance device 20 determines the correction value of the first end point 103A to be 300 mm with reference to the correction value table 35 for the first end point shown in FIG. 8. That is, the parking assistance device 20 corrects the position of the first end point 103A to a position shifted by 300 mm in the X axis direction.

When it is detected that the occupants are seated on the seats 30A, 30B, 30C, and 30D and the image capturing device 11B is located in the region 105A, the parking assistance device 20 determines the correction value of the first end point 103A to be 400 mm with reference to the correction value table 35 for the first end point shown in FIG. 8. That is, the parking assistance device 20 corrects the position of the first end point 103A to a position shifted by 400 mm in the X axis direction.

In this way, as the number of occupants increases, the correction value of the first end point 103A may increase.

When it is detected that the occupant is seated on the seat 30A and the image capturing device 11B is located in the region 105B, the parking assistance device 20 determines the correction value of the first end point 103A to be 50 mm with reference to the correction value table 35 for the first end point shown in FIG. 8. That is, the parking assistance device 20 corrects the position of the first end point 103A to a position shifted by 50 mm in the X axis direction.

When the occupant is seated on the seat 30A and the image capturing device 11B is located in the region 105C, the parking assistance device 20 determines the correction value of the first end point 103A to be 20 mm with reference to the correction value table 35 for the first end point shown in FIG. 8. That is, the parking assistance device 20 corrects the position of the first end point 103A to a position shifted by 20 mm in the X axis direction.

In this way, even when the number of occupants and the seating position are the same, the correction value of the first end point 103A may be different when the region where the image capturing device 11B is located is different.

It should be noted that the parking assistance device 20 may perform the same processing on the other items of the correction value table 35 for the first end point shown in FIG. 8.

<Method for Determining Correction Value of Second End Point when Opening Width is 3500 mm>

The method for determining the correction value of the second end point 103B will be described with reference to FIG. 9. FIG. 9 shows an example of the correction value table 36 for the second end point when the opening width is 3500 mm.

The parking assistance device 20 may determine the correction value of the second end point 103B using the correction value table 36 for the second end point shown in FIG. 9, similarly to the case of determining the correction value of the first end point 103A using the correction value table 35 for the first end point shown in FIG. 8 described above. For example, when the opening width is 3500 mm, the parking assistance device 20 performs the following processing.

When it is detected that the occupant is seated on the seat 30A and the image capturing device 11B is located in the region 105A, the parking assistance device 20 determines the correction value of the second end point 103B to be 10 mm with reference to the correction value table 36 for the second end point shown in FIG. 9. That is, the parking assistance device 20 corrects the position of the second end point 103B to a position shifted by 10 mm in the X axis direction.

When it is detected that the occupants are seated on the seats 30A and 30B and the image capturing device 11B is located in the region 105A, the parking assistance device 20 determines the correction value of the second end point 103B to be 20 mm with reference to the correction value table 36 for the second end point shown in FIG. 9. That is, the parking assistance device 20 corrects the position of the second end point 103B to a position shifted by 20 mm in the X axis direction.

When it is detected that the occupants are seated on the seats 30A, 30B, and 30C and the image capturing device 11B is located in the region 105A, the parking assistance device 20 determines the correction value of the second end point 103B to be 40 mm with reference to the correction value table 36 for the second end point shown in FIG. 9. That is, the parking assistance device 20 corrects the position of the second end point 103B to a position shifted by 40 mm in the X axis direction.

When it is detected that the occupants are seated on the seats 30A, 30B, 30C, and 30D and the image capturing device 11B is located in the region 105A, the parking assistance device 20 determines the correction value of the second end point 103B to be 70 mm with reference to the correction value table 36 for the second end point shown in FIG. 9. That is, the parking assistance device 20 corrects the position of the second end point 103B to a position shifted by 70 mm in the X axis direction.

In this way, as the number of occupants increases, the correction value of the second end point 103B may increase.

When it is detected that the occupants are seated on the seats 30A, 30B, 30C, and 30D and the image capturing device 11B is located in the region 105B, the parking assistance device 20 determines the correction value of the second end point 103B to be 80 mm with reference to the correction value table 36 for the second end point shown in FIG. 9. That is, the parking assistance device 20 corrects the position of the second end point 103B to a position shifted by 80 mm in the X axis direction.

When it is detected that the occupants are seated on the seats 30A, 30B, 30C, and 30D and the image capturing device 11B is located in the region 105C, the parking assistance device 20 determines the correction value of the second end point 103B to be 90 mm with reference to the correction value table 36 for the second end point shown in FIG. 9. That is, the parking assistance device 20 corrects the position of the second end point 103B to a position shifted by 90 mm in the X axis direction.

In this way, even when the number of occupants and the seating position are the same, the correction value of the second end point 103B may be different when the region where the image capturing device 11B is located is different.

The parking assistance device 20 may change the correction values of the first end point 103A and the second end point 103B according to the position of the vehicle 1 in a Y axis direction shown in FIG. 7.

<Method for Determining Correction Value of First End Point when Opening Width is 2300 mm>

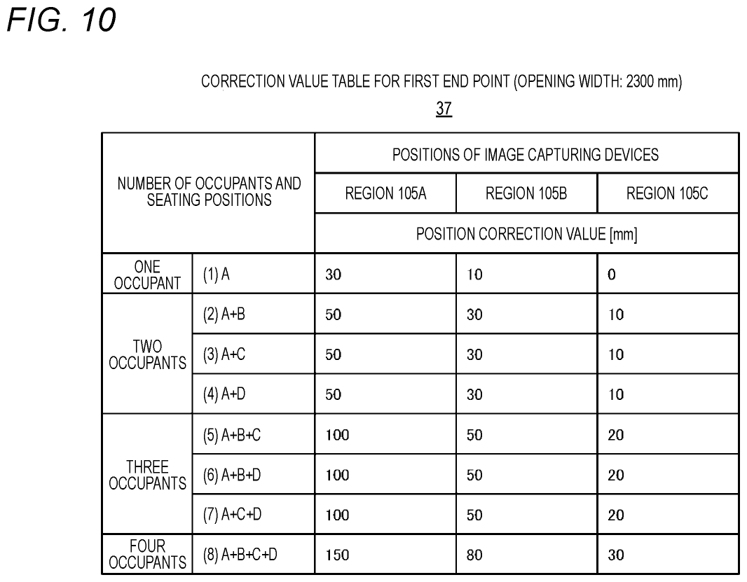

The correction value of the first end point may vary depending on the opening width. Next, a method for determining the correction value of the first end point 103A when the opening width is 2300 mm will be described with reference to FIG. 10. FIG. 10 shows an example of a correction value table 37 for the first end point when the opening width is 2300 mm.

The parking assistance device 20 may determine the correction value of the first end point 103A by using the correction value table 37 for the first end point when the opening width is 2300 mm shown in FIG. 10, similarly to the case of determining the correction value of the first end point 103A by using the correction value table 35 for the first end point when the opening width is 3500 mm shown in FIG. 8 described above. For example, when the opening width is 2300 mm, the parking assistance device 20 performs the following processing.

When it is detected that the occupant is seated on the seat 30A and the image capturing device 11B is located in the region 105A, the parking assistance device 20 determines the correction value of the first end point 103A to be 30 mm with reference to the correction value table 37 for the first end point shown in FIG. 10. That is, the parking assistance device 20 corrects the position of the first end point 103A to a position shifted by 30 mm in the X axis direction.

When it is detected that the occupants are seated on the seats 30A and 30B and the image capturing device 11B is located in the region 105A, the parking assistance device 20 determines the correction value of the first end point 103A to be 50 mm with reference to the correction value table 37 for the first end point shown in FIG. 10. That is, the parking assistance device 20 corrects the position of the first end point 103A to a position shifted by 50 mm in the X axis direction.

When it is detected that the occupants are seated on the seats 30A, 30B, and 30C and the image capturing device 11B is located in the region 105A, the parking assistance device 20 determines the correction value of the first end point 103A to be 100 mm with reference to the correction value table 37 for the first end point shown in FIG. 10. That is, the parking assistance device 20 corrects the position of the first end point 103A to a position shifted by 100 mm in an X axis direction.

When it is detected that the occupants are seated on the seats 30A, 30B, 30C, and 30D and the image capturing device 11B is located in the region 105A, the parking assistance device 20 determines the correction value of the first end point 103A to be 150 mm with reference to the correction value table 37 for the first end point shown in FIG. 10. That is, the parking assistance device 20 corrects the position of the first end point 103A to a position shifted by 150 mm in the X axis direction.

In this way, as the number of occupants increases, the correction value of the first end point 103A may increase.

When it is detected that the occupant is seated on the seat 30A and the image capturing device 11B is located in the region 105B, the parking assistance device 20 determines the correction value of the first end point 103A to be 10 mm with reference to the correction value table 37 for the first end point shown in FIG. 10. That is, the parking assistance device 20 corrects the position of the first end point 103A to a position shifted by 10 mm in the X axis direction.

When it is detected that the occupant is seated on the seat 30A and the image capturing device 11B is located in the region 105C, the parking assistance device 20 determines the correction value of the first end point 103A to be 0 mm with reference to the correction value table 37 for the first end point shown in FIG. 10. That is, the parking assistance device 20 does not correct the position of the first end point 103A.

In this way, even when the number of occupants and the seating position are the same, the correction value of the first end point 103A may be different when the region where the image capturing device 11B is located is different.

It should be noted that the parking assistance device 20 may perform the same processing on the other items of the correction value table 37 for the first end point shown in FIG. 10.

<Method for Determining Correction Value of Second End Point when Opening Width is 2300 mm>

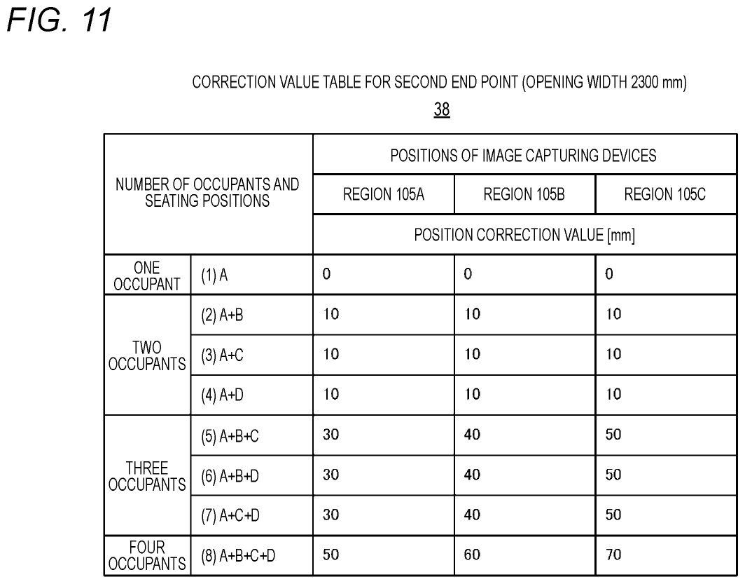

A method for determining the correction value of the second end point 103B will be described with reference to FIG. 11. FIG. 11 shows an example of a correction value table 38 for the second end point when the opening width is 2300 mm.

The parking assistance device 20 may determine the correction value of the second end point 103B by using the correction value table 38 for the second end point when the opening width is 2300 mm shown in FIG. 11, similarly to the case of determining the correction value of the second end point 103B by using the correction value table 36 for the second end point when the opening width is 3500 mm shown in FIG. 9 described above. For example, when the opening width is 2300 mm, the parking assistance device 20 performs the following processing.

When it is detected that the occupant is seated on the seat 30A and the image capturing device 11B is located in the region 105A, the parking assistance device 20 determines the correction value of the second end point 103B to be 0 mm with reference to the correction value table 38 for the second end point shown in FIG. 11. That is, the parking assistance device 20 does not correct the position of the second end point 103B.

When it is detected that the occupants are seated on the seats 30A and 30B and the image capturing device 11B is located in the region 105A, the parking assistance device 20 determines the correction value of the second end point 103B to be 10 mm with reference to the correction value table 38 for the second end point shown in FIG. 11. That is, the parking assistance device 20 corrects the position of the second end point 103B to a position shifted by 10 mm in the X axis direction.

When it is detected that the occupants are seated on the seats 30A, 30B, and 30C and the image capturing device 11B is located in the region 105A, the parking assistance device 20 determines the correction value of the second end point 103B to be 30 mm with reference to the correction value table 38 for the second end point shown in FIG. 11. That is, the parking assistance device 20 corrects the position of the second end point 103B to a position shifted by 30 mm in the X axis direction.

When it is detected that the occupants are seated on the seats 30A, 30B, 30C, and 30D and the image capturing device 11B is located in the region 105A, the parking assistance device 20 determines the correction value of the second end point 103B to be 50 mm with reference to the correction value table 38 for the second end point shown in FIG. 11. That is, the parking assistance device 20 corrects the position of the second end point 103B to a position shifted by 50 mm in the X axis direction.

In this way, as the number of occupants increases, the correction value of the second end point 103B may increase.

When it is detected that the occupants are seated on the seats 30A, 30B, 30C, and 30D and the image capturing device 11B is located in the region 105B, the parking assistance device 20 determines the correction value of the second end point 103B to be 60 mm with reference to the correction value table 38 for the second end point shown in FIG. 11. That is, the parking assistance device 20 corrects the position of the second end point 103B to a position shifted by 60 mm in the X axis direction.

When it is detected that the occupants are seated on the seats 30A, 30B, 30C, and 30D and the image capturing device 11B is located in the region 105C, the parking assistance device 20 determines the correction value of the second end point 103B to be 70 mm with reference to the correction value table 38 for the second end point shown in FIG. 11. That is, the parking assistance device 20 corrects the position of the second end point 103B to a position shifted by 70 mm in the X axis direction.

In this way, even when the number of occupants and the seating position are the same, the correction value of the second end point 103B may be different when the region where the image capturing device 11B is located is different.

It should be noted that the parking assistance device 20 may perform the same processing on the other items of the correction value table 38 for the second end point shown in FIG. 11.

In this way, when the opening width is different, the correction value of the distance between the end points may be different. For example, when the opening width decreases, the correction value of the distance between the end points may decrease.

Through the above processing, the parking assistance device 20 can appropriately correct the position of at least one of the first end point 103A and the second end point 103B according to at least one of the number of occupants in the vehicle 1, the seating position of the occupant, and the relative position of the image capturing device 11B with respect to the target parking frame 41. Therefore, the parking assistance device 20 can estimate the target parking frame 41 with a higher accuracy using the corrected positions of the first end point 103A and the second end point 103B. That is, the parking assistance device 20 can estimate the target parking frame 41 with the high accuracy and reduce an error of the parking position of the vehicle 1 with respect to the target parking frame 41.

(Summary of the Present Disclosure)

The contents of the present disclosure can be expressed as follows.

<Item 1>

The parking assistance device 20 configured to assist parking of the vehicle 1 includes: the communication interface 23 configured to receive an image obtained by capturing an image of a parking frame from the image capturing device 11 included in the vehicle 1; and the processor 21 configured to determine, based on the number of occupants in the vehicle 1, correction values of positions of the end points 103A and 103B of the parking frame detected from the received image.

Accordingly, the parking assistance device 20 can appropriately correct the deviation of the positions of the end points 103A and 103B of the parking frame detected from the image, which may occur depending on the number of occupants in the vehicle 1. Therefore, the vehicle 1 can be parked in the parking frame in which the positional deviation is corrected with high accuracy.

<Item 2>

In the parking assistance device 20 described in Item 1, the correction value may increase as the number of occupants increases.

Accordingly, the parking assistance device 20 can determine the correction value according to the number of occupants in the vehicle 1.

<Item 3>

In the parking assistance device 20 described in Item 1 or 2, the processor 21 may determine the correction value based on a seating position of each of the occupants in the vehicle 1.

Accordingly, the parking assistance device 20 can determine the correction value according to the seating position of the occupant in the vehicle 1.

<Item 4>

In the parking assistance device 20 described in any one of Items 1 to 3, the processor 21 may determine the correction value based on the relative positions of the image capturing device 11 with respect to the end points 103A and 103B.

Accordingly, the parking assistance device 20 can determine the correction value according to the relative positions of the image capturing device 11 with respect to the end points 103A and 103B.

<Item 5>

In the parking assistance device 20 described in any one of Items 1 to 4, the end points 103A and 103B may include the first end point 103A and the second end point 103B respectively corresponding to the two lines 102A and 102B defining the parking frame, and the processor 21 may determine the correction value of the position of the first end point 103A and the correction value of the position of the second end point 103B.

Accordingly, the parking assistance device 20 can determine the correction value of the position of the first end point 103A and the correction value of the position of the second end point 103B.

<Item 6>

In the parking assistance device 20 described in any one of Items 1 to 5, the processor 21 may determine the correction value based on an actual distance between the two lines 102A and 102B defining the parking frame.

Accordingly, the parking assistance device 20 can determine the appropriate correction value according to the actual distance between the two lines 102A and 102B defining the parking frame.

<Item 7>

A parking assistance method for assisting parking of the vehicle 1 includes: receiving an image obtained by capturing an image of a parking frame from the image capturing device 11 included in the vehicle 1; and determining, based on the number of occupants in the vehicle 1, correction values of positions of the end points 103A and 103B of the parking frame detected from the received image.

Accordingly, in the parking assistance method, the deviation of the positions of the end points 103A and 103B of the parking frame detected from the image can be appropriately corrected, which may occur depending on the number of occupants in the vehicle 1. Therefore, the vehicle 1 can be parked in the parking frame with the high accuracy.

<Item 8>

The vehicle 1 includes: the image capturing device 11 configured to capture an image of an outside of the vehicle 1; the detection device 17 configured to detect the number of occupants in the vehicle 1; the parking assistance device 20 configured to receive an image obtained by capturing an image of a parking frame from the image capturing device 11, determine correction values of positions of the end points 103A and 103B of the parking frame detected from the received image based on the number of occupants detected by the detection device 17, and specify a path for parking the vehicle 1 in the parking frame corrected by using the determined correction value; and the movement control device 16 configured to control movement of the vehicle 1 based on the specified path.

Accordingly, the vehicle 1 can appropriately correct the deviation of the positions of the end points 103A and 103B of the parking frame detected from the image, which may occur depending on the number of occupants in the vehicle 1. Therefore, the vehicle 1 can be parked in the parking frame in which the positional deviation is corrected with high accuracy.

Although the embodiment has been described with reference to the accompanying drawings, the present disclosure is not limited to such an example. It is apparent to those skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. Components in the above-described embodiment may be optionally combined within a range not departing from the scope of the invention.

The technology of the present disclosure is applicable to a vehicle, and is useful, for example, in a case where the vehicle is to be parked in a parking frame.

This application is based on and claims priority under 35 USC 119 from Japanese Patent Application No. 2021-161236 filed on Sep. 30, 2021, the contents of which are incorporated herein by reference.

What is claimed is:

1. A parking assistance device configured to assist parking of a vehicle, the parking assistance device comprising:
a communication interface;
a processor; and
a memory storing instructions that, when executed by the processor, cause the parking assistance device to perform operations, the operations comprising:
obtaining an image of a parking frame through the communication interface, the image being captured by an image capturing device provided in the vehicle; and
determining, based on a number of one or more occupants in the vehicle, a correction value of a position of each of at least one end point of the parking frame detected from the image.

2. The parking assistance device according to claim 1,
wherein the correction value increases as the number of one or more occupants increases.

3. The parking assistance device according to claim 1,
wherein the correction value is determined based on a seating position of each of the one or more occupants in the vehicle.

4. The parking assistance device according to claim 1,
wherein the correction value is determined based on a position of the image capturing device relative to each of the at least one end point.

5. The parking assistance device according to claim 4,
wherein the at least one end point includes a first end point and a second end point respectively corresponding to two lines defining the parking frame, and
wherein the determining the correction value comprises determining a first correction value of a position of the first end point and a second correction value of a position of the second end point.

6. The parking assistance device according to claim 5,
wherein the first end point and the second end point are end points at an entrance of the parking frame.

7. The parking assistance device according to claim 6,
wherein the position of the image capturing device relative to each of the at least one end point is a position of the image capturing device relative to each of the at least one end point in a width direction of the entrance of the parking frame.

8. The parking assistance device according to claim 7,
wherein the position of the image capturing device relative to each of the at least one end point is a range in which the image capturing device is located relative to each of the at least one end point, the range being of a plurality of ranges divided along the width direction of the entrance of the parking frame.

9. The parking assistance device according to claim 8,
wherein at least one of the first correction value and the second correction value increases as the number of the one or more occupants increases.

10. The parking assistance device according to claim 9,
wherein at least one of the first correction value and the second correction value corrects a width of the entrance of the parking frame to be larger as the number of the one or more occupants increases.

11. The parking assistance device according to claim 1,
wherein the at least one end point includes a first end point and a second end point respectively corresponding to two lines defining the parking frame, and
wherein the determining the correction value comprises determining a first correction value of a position of the first end point and a second correction value of a position of the second end point.

12. The parking assistance device according to claim 11,
wherein at least one of the first correction value and the second correction value increases as the number of the one or more occupants increases.

13. The parking assistance device according to claim 12,
wherein the first end point and the second end point are end points at an entrance of the parking frame.

14. The parking assistance device according to claim 13,
wherein at least one of the first correction value and the second correction value corrects a width of the entrance of the parking frame to be larger as the number of the one or more occupants increases.

15. The parking assistance device according to claim 1,
wherein the correction value is determined based on an actual distance between two lines defining the parking frame.

16. The parking assistance device according to claim 15,
wherein the correction value increases as the number of the one or more occupants increases.

17. The parking assistance device according to claim 16,
wherein the two lines define an entrance of the parking frame.

18. The parking assistance device according to claim 17,
wherein the correction value corrects a width of the entrance of the parking frame to be larger as the number of the one or more occupants increases.

19. A parking assistance method for assisting parking of a vehicle, the parking assistance method comprising:
obtaining an image of a parking frame captured by an image capturing device provided in the vehicle; and
determining, based on a number of one or more occupants in the vehicle, a correction value of a position of an end point of the parking frame detected from the image.

20. A vehicle comprising:
an image capturing device;
a detection device;
at least one processor; and
at least one memory storing instructions that, when executed by the at least one processor, cause the vehicle to perform operations, the operations comprising:
obtaining an image of a parking frame captured by the image capturing device;
determining, based on detection information detected by the detection device indicating a number of one or more occupants in the vehicle, a correction value of a position of an end point of the parking frame detected from the image;
specifying a path for parking the vehicle in the parking frame corrected by using the correction value; and
controlling movement of the vehicle based on the path.
